(19) United States
(12) Patent Application Publication
(10) Pub. No.: US 2026/0003040 A1
(43) Pub. Date: Jan. 1, 2026

(54) MOE-based optics for FMCW LiDAR

(71) Applicant: APPLE INC., Cupertino, CA (US)

(72) Inventors: Igor Raginski, San Diego, CA (US); Vyshakh Sanjeev, San Francisco, CA (US); Omer Korech, Pardes Hanna Karkur (IL); Shingo Mandai, Mountain View, CA (US); Cristiano L. Niclass, San Jose, CA (US); Maoz Ovadia, Kiryat Ono (IL); Scott T. Smith, San Jose, CA (US); Yohai Zmora, San Francisco, CA (US)

(21) Appl. No.: 19/096,779

(22) Filed: Apr. 1, 2025

Related U.S. Application Data
(60) Provisional application No. 63/665,868, filed on Jun. 28, 2024.

(51) Int. Cl. G01S 7/481; G01S 7/4861; G01S 7/4914; G01S 7/493; G02B 1/00; G02B 27/10; G02B 27/30

(52) U.S. Cl. CPC G01S 7/4811; G01S 7/4861; G01S 7/4914; G01S 7/493; G02B 1/002; G02B 27/1093; G02B 27/30

(57) ABSTRACT

Optical sensing apparatus includes a transmitter, which emits frequency-modulated (FM) coherent optical radiation along a transmit axis toward a target, and a receiver, which is disposed alongside the transmitter and comprises an array of detectors. An objective optic focuses the optical radiation that is reflected from the target onto the receiver along a receive axis. A transparent slab, disposed over the transmitter and receiver, includes a diffractive surface, which deflects a part of the FM coherent optical radiation to form a local beam propagating diagonally within the transparent slab and reflecting from within the slab toward the receive axis. A collimating metasurface on the slab, intercepting the receive axis, deflects and collimates the reflected local beam onto the array of detectors, whereby the local beam mixes at the array with the optical radiation reflected from the target.

### CROSS-REFERENCE TO RELATED APPLICATION

This application claims the benefit of U.S. Provisional Patent Application 63/665,868, filed Jun. 28, 2024, which is incorporated herein by reference.

### FIELD OF THE INVENTION

The present invention relates generally to systems and methods for optical sensing, and particularly to FMCW LiDAR sensing.

### BACKGROUND

In frequency-modulated continuous-wave (FMCW) light detection and ranging (LiDAR) sensing arrangements, a radio-frequency (RF) chirp is applied to modulate the frequency of a beam of optical radiation (typically a single-mode laser beam) that is directed toward a target. The optical radiation reflected from the target is mixed with a sample of the transmitted light, referred to as a “local oscillator” or “local beam.” The mixed optical radiation is detected by a photodetector, which then outputs an RF signal at a beat frequency that is proportional to the distance to the target. When the target is moving, the resulting Doppler shift of the reflected optical radiation will cause the beat frequency to increase or decrease, depending on the direction of motion.

By comparing the beat frequencies obtained from chirps of positive and negative slopes, it is thus possible to extract both the range and the velocity of the target. In the ideal case, if the beat frequency due to the Doppler shift is d, and the beat frequency due to the chirp and range is r, then the measured beat frequency for the up-chirp will be fᵤ=d+r, and the beat frequency on the down-chirp will be f_{d}=r−d. Thus, the difference between the measured up and down chirp frequencies reveals the Doppler shift, and the sum reveals the range.

Optical metasurfaces are thin layers that comprise a two-dimensional pattern of structures (so-called meta-atoms), having dimensions (pitch and thickness) less than or on the order of the target wavelength of the radiation with which the metasurface is designed to interact. A metasurface is a type of diffractive surface, whose properties are determined by the design of the meta-atoms. Optical elements comprising optical metasurfaces are referred to herein as “metasurface optical elements” (MOEs).

Diffractive optical elements (DOEs) comprise diffractive structures, which split and/or deflect optical radiation. An MOE can be considered to be a type of DOE.

The terms “light” and “optical radiation,” as used in the context of the present description and in the claims, refer to electromagnetic radiation in any of the visible, ultraviolet, and infrared spectral bands.

### SUMMARY

Embodiments of the present invention that are described hereinbelow provide improved apparatus and methods for optical sensing.

There is therefore provided, in accordance with an embodiment of the invention, optical sensing apparatus, including a substrate and a transmitter, which is disposed on the substrate and is configured to emit frequency-modulated (FM) coherent optical radiation along a transmit axis toward a target. A receiver is disposed on the substrate alongside the transmitter and includes an array of detectors of optical radiation. An objective optic is configured to focus the optical radiation that is reflected from the target onto the receiver along a receive axis. A transparent slab is disposed over the transmitter and the receiver and has a first face facing the substrate and a second face opposite the first face. The transparent slab includes a diffractive surface, which is disposed on the first face in a first location intercepting the transmit axis and is configured to deflect a part of the FM coherent optical radiation to form a local beam propagating diagonally within the transparent slab and reflecting from the second face toward the receive axis; and a collimating metasurface, which is disposed on the first face in a second location intercepting the receive axis and is configured to deflect and collimate the reflected local beam onto the array of detectors, whereby the local beam mixes at the array with the optical radiation reflected from the target.

In a disclosed embodiment, the apparatus includes processing circuitry, which is configured to receive electrical signals from the array of detectors in response to the mixed optical radiation and to extract a beat frequency from the electrical signals.

In some embodiments, the diffractive surface includes a beamsplitting metasurface, which is configured to deflect the local beam while passing a remainder of the FM coherent optical radiation toward the target. In one embodiment, the beamsplitting metasurface is further configured to collimate the remainder of the FM coherent optical radiation. Alternatively, the apparatus includes a further diffractive surface, which is configured to split the remainder of the FM coherent optical radiation into multiple sub-beams, which form an array of spots on the target. In a disclosed embodiment, the further diffractive surface is disposed on the second face of the transparent slab.

In some embodiments, the objective optic includes a focusing metasurface. In one embodiment, the focusing metasurface is interleaved with the collimating metasurface on the first face of the transparent slab. The focusing metasurface may be configured to inhibit diffraction of the local beam toward the receiver, thereby preventing a part of the local beam that is not collimated by the collimating metasurface from impinging on the array of detectors.

In other embodiments, the optical radiation that is reflected from the target is focused by the objective optic through an area of the second face on the receive axis, and the collimating metasurface covers multiple sub-areas distributed across the area and occupying less than 20% of the area. In one embodiment, the multiple sub-areas are arranged in a matrix having a pitch such that each sub-area is aligned with a respective detector in the array, and a distance from the collimating metasurface to the array is an integer multiple of a Talbot-length determined by the pitch.

In a disclosed embodiment, the detectors include single-photon avalanche photodiodes (SPADS).

There is also provided, in accordance with an embodiment of the invention, a method for optical sensing, which includes emitting frequency-modulated (FM) coherent optical radiation along a transmit axis from a transmitter toward a target. Optical radiation that is reflected from the target is focused along a receive axis onto a receiver, which includes an array of detectors of the optical radiation. A transparent slab is positioned over the transmitter and the receiver. The transparent slab has a first face facing the substrate and a second face opposite the first face and includes a diffractive surface, which is disposed on the first face in a first location intercepting the transmit axis and is configured to deflect a part of the FM coherent optical radiation to form a local beam propagating diagonally within the transparent slab and reflecting from the second face toward the receive axis; and a collimating metasurface, which is disposed on the first face in a second location intercepting the receive axis and is configured to deflect and collimate the reflected local beam onto the array of detectors, whereby the local beam mixes at the array with the optical radiation reflected from the target.

The present invention will be more fully understood from the following detailed description of the embodiments thereof, taken together with the drawings in which:

### BRIEF DESCRIPTION OF THE DRAWINGS

FIG. 1 is a schematic sectional view of an optical sensing apparatus, in accordance with an embodiment of the invention; and

FIG. 2 is a schematic sectional view of an optical sensing apparatus, in accordance with another embodiment of the invention.

### DETAILED DESCRIPTION OF EMBODIMENTS

### Overview

Some FMCW LiDAR sensing apparatuses build a depth map of a target by emitting frequency-modulated (FM) coherent optical radiation toward the target. The optical radiation reflected from the target is imaged onto an array of detectors, where it is mixed with a local beam. The beat frequencies output by the detectors are analyzed to determine the distance to and velocity of each point on the target. To generate strong beat signals, it is important that the optics project and collect the optical radiation efficiently, with accurate focusing of the reflected radiation onto the detectors and with high overlap with the local beam. At the same time, in many applications, such as in mobile devices, space is at a premium, and the optical component count and total track length should be held to a minimum.

Embodiments of the present invention that are described herein provide an FMCW LiDAR sensing apparatus with an optical architecture based on a transparent slab with diffractive surfaces, including at least one optical metasurface, that perform multiple functions. These surfaces deflect the local beam to pass through the slab and collimate the local beam onto the detector array. The slab thus combines several optical functions into a small number of components, simplifying the fabrication of the apparatus and reducing its size.

In the disclosed embodiments, an optical sensing apparatus has a transmitter and a receiver on a substrate. The transmitter emits FM coherent optical radiation along a transmit axis toward a target. The receiver comprises an array of detectors of optical radiation. An objective optic (as a part of the optical train of the receiver) focuses the optical radiation that is reflected from the target onto the array of detectors along a receive axis. A transparent slab is disposed over both the transmitter and the receiver. A diffractive surface on the first face of the slab, facing the substrate, intercepts the transmit axis and deflects a part of the FM coherent optical radiation to form a local beam propagating diagonally within the transparent slab. This local beam reflects from the second face of the slab toward a collimating metasurface on the first face of the slab, which intercepts the receive axis. The collimating metasurface deflects and collimates the reflected local beam onto the array of detectors, whereby the local beam mixes at the array with the optical radiation reflected from the target.

A number of variants on this basic system architecture are described hereinbelow. For example, in some embodiments, the diffractive surface on the transmit axis is a beamsplitting metasurface, which may also collimate the remainder of the FM coherent optical radiation that is transmitted toward the target, and/or collimates the local beam. Additionally or alternatively, the objective optic may comprise a focusing metasurface, which may be interleaved with the collimating metasurface on the first face of the slab. Further embodiments are described below.

### System Description

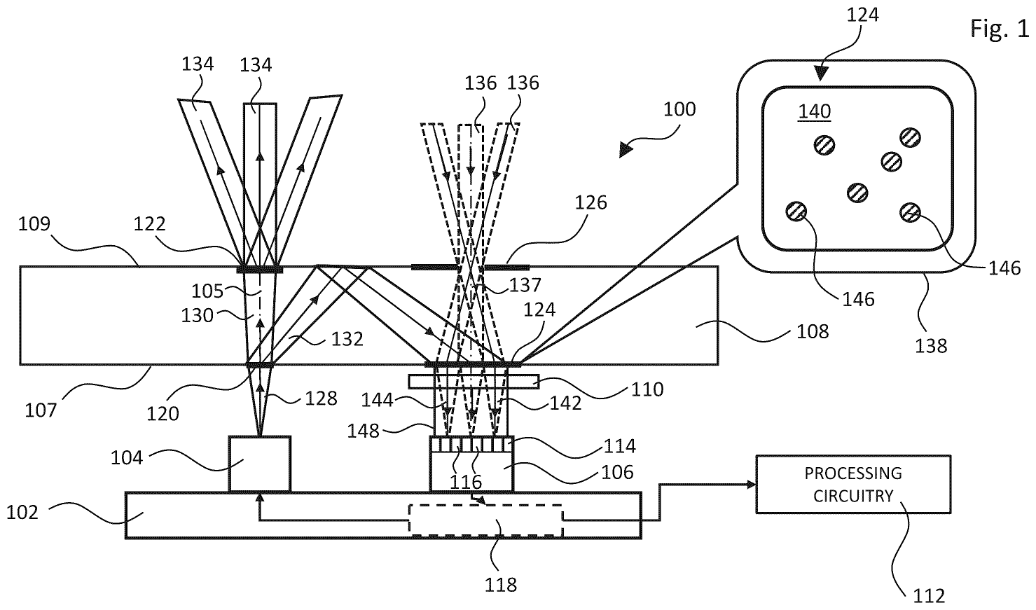

FIG. 1 is a schematic sectional view of an optical sensing apparatus 100, in accordance with an embodiment of the invention. Apparatus 100 comprises a substrate 102, such as a silicon chip, on which are disposed a transmitter 104 and a receiver 106. Apparatus 100 further comprises a transparent, plane-parallel slab 108, an optional bandpass filter 110 for reducing the impact of ambient light, and processing circuitry 112.

Transmitter 104 comprises a single-mode or multi-mode continuous-wave coherent emitter, such as a vertical-cavity surface-emitting laser (VCSEL) or vertical-external-cavity surface-emitting laser (VeCSEL). Transmitter 104 emits optical radiation along a transmit axis 105 toward a target (not shown). The emitted radiation is typically at a near-infrared wavelength (NIR, for example 940 nm) or at a short-wavelength infrared wavelength (SWIR, for example 1300 nm). Transmitter 104 is typically fabricated from a III-V (direct bandgap) material and bonded to substrate 102. Alternatively, other types of emitters of coherent optical radiation may be used, possible with other emission wavelengths. Further alternatively, an array of emitters, such as an array of VCSELs, may be used.

Receiver 106 comprises an array 114 of detectors 116 of optical radiation. The detectors may advantageously comprise single-photon avalanche-photodiodes (SPADs), for example as described in U.S. patent application Ser. No. 18/623,080, filed Apr. 1, 2024, whose disclosure is incorporated herein by reference. Alternatively, other types of detectors may be used, such as balanced pairs of photodiodes. Detectors 116 are made from, for example, doped silicon or silicon-germanium (SiGe).

Driving and amplification circuitry 118 on substrate 102 is coupled to transmitter 104, receiver 106, and processing circuitry 112, and provides drive signals to the transmitter and amplification and processing for the receiver output. Driving and amplification circuitry 118 may alternatively be external to substrate 102. Further alternatively, processing circuitry 112 may be integrated on substrate 102 with driving and amplification circuitry 118. Processing circuitry 112 receives electrical signals output from detectors 116 via driving and amplification circuitry 118 and extracts beat frequency from the electrical signals. Processing circuitry 112 and driving and amplification circuitry 118 comprise analog and/or digital electronic components for carrying out the functions that are described herein.

Slab 108 is made of glass, plastic, or other material transparent at the wavelength of optical radiation emitted by transmitter 104. Slab 108 is disposed over both transmitter 104 and receiver 106 and has a first face 107, facing substrate 102, and a second face 109 opposite the first face. Slab 108 comprises a diffractive surface 120 and a collimating metasurface 124 on first face 107, and a beamsplitting and collimating diffractive surface 122, as well as an optical aperture 126 on second face 109. Optical aperture 126 may also comprise a low-power MOE to correct for possible spherical aberration of collimating metasurface 124. The structures and the functions of surfaces 120, 122, and 124 are described together with the description of the 41 functionality of apparatus 100 hereinbelow.

For mapping a target, transmitter 104 emits coherent continuous-wave optical radiation into a conical beam 128 along transmit axis 105, while the wavelength (frequency) of the radiation is modulated by circuitry 118. Beam 128 impinges on surface 120, which comprises a one-dimensional grating. The grating splits beam 128 into a transmitted beam 130 (0^{th} diffracted order of the grating), which is transmitted toward the target, and into a local beam 132 (a single first-order or higher diffracted order of the grating). Optionally, surface 120 may comprise a beamsplitting metasurface, with added optical power, for example to collimate beam 130 or, in the case of multiple emitters, to collimate beam 132. The angle into which surface 120 deflects local beam 132 is selected, taking into account the refractive index of slab 108, so that the local beam propagates in slab 108 by total internal reflection (TIR), reflecting from face 109 and impinging on surface 124. A reflective coating may be added in selected locations on faces 107, 109 of slab 108 for ensuring reflections of marginal rays of local beam 132 within the element.

Beam 130 is transmitted through slab 108 onto diffractive surface 122, which may comprise a metasurface. Surface 122 collimates beam 130 by adding a hyperbolic phase to the beam in the case of single emitter, or a parabolic phase in case of multiple emitters, while splitting the impinging beam into a two-dimensional array of beams 134. The collimating phase @ added by surface 122 may be represented by an equation:

$$Φ = {\sum }_{i = 1}^{∞} {A}_{2 i} {r}^{2 i} ,$$

wherein the coefficient A₂ relates to the effective focal length (EFL) of the collimation:

$${A}_{2} = \frac{π}{λ \times E F L} ,$$

and wherein A₂ᵢ=0 for i>1 in the case of a parabolic phase. The coordinate r denotes the radial coordinate of surface 122 as measured from axis 105.

Beams 134 illuminate the target (not shown) with a pattern of spots. Some of the optical radiation reflected from the target is directed into apparatus 100 as beams 136 through aperture 126, which functions as an optical stop, which pass through slab 108 along a receive axis 137 to metasurface 124. Thus beams 136 returning from the target and local beam 132 impinge on metasurface 124, as further detailed hereinbelow.

Metasurface 124, shown in a frontal view in an inset 138, has a dual functionality:
A focusing area 140 of metasurface 124 functions as the main objective optic (together with possible aberration correction by a low-power MOE added to aperture 126, as noted above), focusing beams 136 onto detector array 114 as cones 142, with chief rays 144 of the cones perpendicular to the array (telecentric design). Focusing area 140 imposes a phase Φ_{F} on beams 136, wherein Φ_{F} is given by:

$${Φ}_{F} = {\sum }_{i = 1}^{∞} {A}_{2 i} {r}^{2 i} .$$

The coordinate r denotes the radial coordinate of optical surface 124 as measured from axis 137.
Collimating areas 146, interleaved with focusing area 140, deflect and collimate local beam 132 onto detector array 114 as a collimated local beam 148 perpendicular to the array. Collimating areas 146 impose a phase Φ_{C} on LO beam 132, given by:

$${Φ}_{C} = {\sum }_{i = 1}^{∞} {A}_{i} {r}^{i} ,$$

The coefficients Aᵢ up to a certain order (for example, i=1, . . . , 10) are optimized for collimation; for higher orders, the coefficients Aᵢ are set to zero.

The perpendicularity of both chief rays 144 and beam 148 to detector array 114, along with overlap between the beam, ensures efficient interference between the signals returning from the target as cones 142 and the collimated local beam 148. Both cones 142 and local beam 148 pass through bandpass filter 110, which reduces the impact of ambient light on the contrast of the interference signal.

The areas, number, and positions of collimating areas 146 are shown in inset 138 only schematically. In embodiments of the invention, the above parameters of the collimating areas are selected to maximize the coupling efficiency of local beam 132 into collimated LO beam 148, while their total surface area is derived from light budget calculations and selected to provide the required ratio between the collimated local beam irradiance and the return signal irradiance on detector array 114. Due to the much lower intensity of beams 136 returning from the target as compared to local beam 132, areas 146 generally occupy only a small fraction of the area of metasurface 124, typically no more than 20% or even much less.

Spatial overlap between collimated local beam 148 and focused cones 142 at the detector array 114 is maximized by optimizing the locations of areas 146. Areas 146 may be formed as discrete islands, as shown in inset 138. Alternatively, other designs, such as concentric rings, may be used for areas 146, wherein the widths of the rings, as compared to the remaining area 140, may be determined by the required ratio between the irradiances on detector array 114 of the local beam and the returning signal beams.

Alternatively to the above-described approach, Talbot-imaging may be applied in illumination of detector array 114 by local beam 148. For this purpose, areas 146 may be arranged in a two-dimensional matrix, with each individual area aligned with a corresponding detector 116. Due to Talbot-imaging, the portion of local beam 132 illuminating areas 146 is replicated after passing surface 124 at the Talbot-length, TL, which is determined by the pitch of the matrix, P, and the wavelength of the optical radiation, A:

$$T L = \frac{λ}{1 - \sqrt{1 - \frac{{λ}^{2}}{{P}^{2}}}} \approx \frac{2 {P}^{2}}{λ}$$

In the above formula, the approximation is valid for λ<<P. Arranging the distance between surface 124 and detector array 114 to be equal to an integer multiple of TL, each detector 116 will be illuminated by a respective part of the local beam. For example, for a pitch of 10 μm of detector array 114 and a transmitter wavelength of 942 nm, the Talbot-length is 212.3 μm. By appropriate choice of the Talbot-imaging parameters and corresponding design of metasurface 124, the overlap and thus the interference between the signals returning from the target as cones 142 and the collimated local beam 148 may be maximized. Alternatively, a numerical propagation calculation, such as the method of Angular Spectrum Decomposition, may be performed, and a distance giving optimal performance may be selected.

Local beam 132 impinges not only on collimating areas 146, but also on focusing area 140. Scatter of uncollimated radiation from the local beam onto array can add noise to the output of detectors 116 and thus degrade the signal-to-noise ratio (SNR) of the beat signal. Therefore, metasurface 124 in focusing area 140 is designed to inhibit diffraction of the local beam toward receiver 106. Specifically, focusing area 140 may have an angle-dependent phase response, which causes the incident local beam to pass through or reflect from focusing area 140 without deflection toward receiver 106. For example, focusing area 140 of metasurface 124 may be designed so that the phase applied to local beam 132 will be constant for all the meta-atoms that constitute the focusing area. Thus, as long as it is propagating through TIR, the local beam incident on focusing area 140 will be diffracted only into the zero order and will not impinge on array 114. In particular, the angular sensitivity of p-polarized optical radiation in reflection and transmission may be utilized for an angle-dependent design of metasurface 124 in area 140, and by setting the polarization of the optical radiation emitted by transmitter 104 accordingly.

### Alternative Embodiment

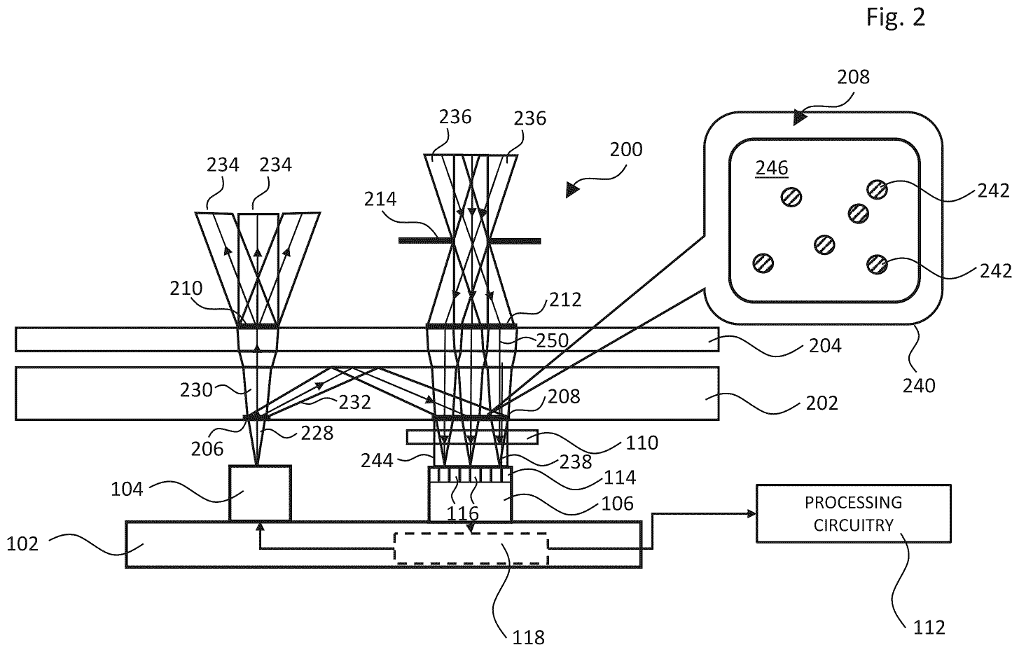

FIG. 2 is a schematic sectional view of an optical sensing apparatus 200, in accordance with another embodiment of the invention. Components of apparatus 200 that are similar or identical to components of apparatus 100 are labeled with the same reference numbers, and their description is omitted here for the sake of brevity.

Apparatus 200 further comprises a lower slab 202 and an upper slab 204, each comprising a transparent, plane-parallel slab made of glass, plastic, or other material transparent at the wavelength of radiation emitted by transmitter 104. Slab 202 comprises a diffractive surface 206 (which may be a metasurface) and a metasurface 208. Slab 204 comprises two metasurfaces 210 and 212. Additionally, apparatus 200 comprises an optical aperture 214. The optical surfaces in apparatus 200 are similar in functionality to those in the embodiment of FIG. 1; but the use of two slabs 202 and 204 relaxes the design constraints and may therefore be capable of achieving improved optical performance, though at the expense of added components and size.

Transmitter 104 in apparatus 200 emits coherent continuous-wave optical radiation into a conical beam 228, while the wavelength (frequency) of the radiation is modulated by circuitry 118. Beam 228 impinges on diffractive surface 206, which splits beam 228 into a transmitted beam 230 (0^{th} diffracted order of the grating) and into a local beam 232 (a single first or higher diffracted order). Local beam 232 propagates in slab 202 by TIR, impinging on metasurface 208.

Beam 230 is transmitted through slab 202 and slab 204 onto metasurface 210, which collimates beam 230 by adding a collimating phase to the beam (similarly to surface 122 in FIG. 1) and splits the impinging beam into a two-dimensional array of beams 234. Beams 234 illuminate a target (not shown) with a pattern of spots. Some of the optical radiation reflected from the target returns to apparatus 200 as beams 236, passing through optical aperture 214, which functions as an optical stop, to metasurface 212. Metasurface 212 functions as objective optic, which adds a collimating phase to the impinging beams 236 (similarly to area 140 of metasurface 124 in FIG. 1), focusing the beams through slabs 204 and 202 and bandpass filter 110 as focused beams 238 onto detector array 114.

In an alternative embodiment, optical aperture 214 (as a mechanical aperture) may be omitted. In this case, a virtual aperture is formed because the overlap integral between beams 236 returning from the target and a collimated local beam 244 nearly vanishes for those beams returning from target that are outside of the virtual aperture. (In an alternative configuration of apparatus 100 in FIG. 1, aperture 126 may similarly be omitted, albeit with less advantage for the fabrication of the apparatus.)

Metasurface 208, shown in a frontal view in an inset 240, comprises areas 242, which—similarly to areas 146 of surface 124 (FIG. 1)—collimate and deflect local beam 232 into a collimated local beam 244, which impinges perpendicularly on detector array 114. Similarly, chief rays 250 of focused beams 238 impinge perpendicularly on detector array 114, thus assuring interference between the focused beams and collimated local beam 244 (given a high value of the overlap integral).

Area 246 of surface 208, i.e., the area outside areas 242, is unpatterned (as opposed to area 140 of surface 124 in FIG. 1), and thus has no effect on and adds no optical power to focused beams 238. The two tasks of focusing of beams 236 and collimation of local beam 232 are thus separated between two respective metasurfaces 212 and 208. This kind of separation simplifies the design and fabrication of metasurface 208, as it comprises now only one sort of metasurface (in areas 242), rather than a compound of different metasurface characteristics. In addition, area 246 is a planar optical surface, thus inherently avoiding spurious diffracted orders of local beam 232.

Similar design considerations as to the areas, number, and positions of areas 146 of surface 124 in FIG. 1 may be applied to areas 242.

Although the embodiments described above illuminate the target with multiple spots of FMCW radiation, in alternative embodiments, metasurface 122 (FIG. 1) or 210 (FIG. 2) may simply collimate the transmitted beam, whereby the target is illuminated uniformly. This latter mode of operation may be useful, for example, in high-resolution sensing of smaller target areas.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Optical sensing apparatus, comprising:
a substrate;
a transmitter, which is disposed on the substrate and is configured to emit frequency-modulated (FM) coherent optical radiation along a transmit axis toward a target;
a receiver, which is disposed on the substrate alongside the transmitter and comprises an array of detectors of optical radiation;
an objective optic configured to focus the optical radiation that is reflected from the target onto the receiver along a receive axis; and
a transparent slab, which is disposed over the transmitter and the receiver and has a first face facing the substrate and a second face opposite the first face, and which comprises:
a diffractive surface, which is disposed on the first face in a first location intercepting the transmit axis and is configured to deflect a part of the FM coherent optical radiation to form a local beam propagating diagonally within the transparent slab and reflecting from the second face toward the receive axis; and
a collimating metasurface, which is disposed on the first face in a second location intercepting the receive axis and is configured to deflect and collimate the reflected local beam onto the array of detectors, whereby the local beam mixes at the array with the optical radiation reflected from the target.

2. The apparatus according to claim 1, and comprising processing circuitry, which is configured to receive electrical signals from the array of detectors in response to the mixed optical radiation and to extract a beat frequency from the electrical signals.

3. The apparatus according to claim 1, wherein the diffractive surface comprises a beamsplitting metasurface, which is configured to deflect the local beam while passing a remainder of the FM coherent optical radiation toward the target.

4. The apparatus according to claim 3, wherein the beamsplitting metasurface is further configured to collimate the remainder of the FM coherent optical radiation.

5. The apparatus according to claim 3, and comprising a further diffractive surface, which is configured to split the remainder of the FM coherent optical radiation into multiple sub-beams, which form an array of spots on the target.

6. The apparatus according to claim 5, wherein the further diffractive surface is disposed on the second face of the transparent slab.

7. The apparatus according to claim 1, wherein the objective optic comprises a focusing metasurface.

8. The apparatus according to claim 7, wherein the focusing metasurface is interleaved with the collimating metasurface on the first face of the transparent slab.

9. The apparatus according to claim 8, wherein the focusing metasurface is configured to inhibit diffraction of the local beam toward the receiver, thereby preventing a part of the local beam that is not collimated by the collimating metasurface from impinging on the array of detectors.

10. The apparatus according to claim 1, wherein the optical radiation that is reflected from the target is focused by the objective optic through an area of the second face on the receive axis, and the collimating metasurface covers multiple sub-areas distributed across the area and occupying less than 20% of the area.

11. The apparatus according to claim 10, wherein the multiple sub-areas are arranged in a matrix having a pitch such that each sub-area is aligned with a respective detector in the array, and wherein a distance from the collimating metasurface to the array is an integer multiple of a Talbot-length determined by the pitch.

12. The apparatus according to claim 1, wherein the detectors comprise single-photon avalanche photodiodes (SPADs).

13. A method for optical sensing, comprising:
emitting frequency-modulated (FM) coherent optical radiation along a transmit axis from a transmitter toward a target;
focusing optical radiation that is reflected from the target along a receive axis onto a receiver, which comprises an array of detectors of the optical radiation; and
positioning a transparent slab over the transmitter and the receiver, the transparent slab having a first face facing the substrate and a second face opposite the first face and comprising:
a diffractive surface, which is disposed on the first face in a first location intercepting the transmit axis and is configured to deflect a part of the FM coherent optical radiation to form a local beam propagating diagonally within the transparent slab and reflecting from the second face toward the receive axis; and
a collimating metasurface, which is disposed on the first face in a second location intercepting the receive axis and is configured to deflect and collimate the reflected local beam onto the array of detectors, whereby the local beam mixes at the array with the optical radiation reflected from the target.

14. The method according to claim 13, and comprising extracting a beat frequency from electrical signals output by the array of detectors in response to the mixed optical radiation.

15. The method according to claim 13, wherein the diffractive surface comprises a beamsplitting metasurface, which is configured to deflect the local beam while passing a remainder of the FM coherent optical radiation toward the target.

16. The method according to claim 15, wherein the beamsplitting metasurface is further configured to collimate the remainder of the FM coherent optical radiation.

17. The method according to claim 15, wherein emitting the FM coherent optical radiation comprises applying a further diffractive surface to split the remainder of the FM coherent optical radiation into multiple sub-beams, which form an array of spots on the target.

18. The method according to claim 13, wherein focusing the optical radiation comprises applying a focusing metasurface, which is interleaved with the collimating metasurface on the first face of the transparent slab, to focus the optical radiation onto the receiver.

19. The method according to claim 13, wherein focusing the optical radiation comprises applying an objective optic to focus the optical radiation that is reflected from the targe through an area of the second face on the receive axis, wherein the collimating metasurface covers multiple sub-areas distributed across the area and occupying less than 20% of the area.

20. The method according to claim 13, wherein the detectors comprise single-photon avalanche photodiodes (SPADS).
